(19) United States
(12) Patent Application Publication
(10) Pub. No.: US 2025/0348465 A1
(43) Pub. Date: Nov. 13, 2025

(54) DATABASE MANAGEMENT SYSTEM PERFORMANCE ISSUE CORRECTION

(71) Applicant: SAP SE, Walldorf (DE)

(72) Inventors: Yang Xu, Xi'an (CN); Qiao-Iuan Xie, Xi'an (CN); Yong Li, Xi'an (CN); Hangyu Zhou, Xi'an (CN)

(21) Appl. No.: 18/661,239

(22) Filed: May 10, 2024

(51) Int. Cl. G06F 16/21; G06F 11/34; G06F 16/2457

(52) U.S. Cl. CPC G06F 16/21; G06F 11/3409; G06F 16/24578

(57) ABSTRACT

Various examples are directed to systems and methods for testing a database management system. A testing system may execute a graph neural network using first performance data describing a plurality of operations executed by a database management system to implement a first query, based at least in part on the graph neural network output, generate first query execution signature data describing the execution of the first query at the database management system. The testing system may compare the first query execution signature data to second query execution signature data describing execution of a second query at the database management system.

### BACKGROUND

Database management systems (DBMS) are used to store, access, and process data. As database management systems are built and/or modified, performance issues may arise. Identifying and correcting database management system performance issues can consume considerable hardware, software, and human resources.

### BRIEF DESCRIPTION OF DRAWINGS

The present disclosure is illustrated by way of example and not limitation in the following figures.

FIG. 1 is a diagram showing one example of an environment comprising a computing system and a testing system.

FIG. 2 is a workflow diagram showing one example of a workflow that may be executed in the environment to determine whether to query executions are equivalent.

FIG. 3 is a workflow diagram showing one example of a workflow that may be executed in the environment to determine whether to query executions are equivalent.

FIG. 4 is a flowchart showing one example of a process flow that may be executed in the environment of FIG. 1 to determine whether to query executions are equivalent.

FIG. 5 is a flowchart showing one example of a process flow that may be executed by the graph engine of FIG. 1 to generate a key operations graph.

FIG. 6 is a diagram illustrating an example of an in-memory database management system.

FIG. 7 is a diagram illustrating an example of the index server of FIG. 6.

FIG. 8 is a diagram illustrating one example of the request processing and execution control of FIG. 7.

FIG. 9 is a block diagram showing one example of a software architecture for a computing device.

FIG. 10 is a block diagram of a machine in the example form of a computer system within which instructions may be executed for causing the machine to perform any one or more of the methodologies discussed herein.

### DETAILED DESCRIPTION

Various examples described herein are directed to systems and methods for identifying duplicate database management system (DBMS) performance issues.

In various examples, a DBMS may be tested over a number of different use scenarios. Use scenarios may be developed by the DBMS development team and/or, in some examples, received from customer enterprises who use the DBMS. A use scenario may comprise one or more queries directed to the DBMS. An output of the use scenario may comprise data from the DBMS, for example, arranged in a manner requested by the query. The use scenarios may be executed at the DBMS. A development team for the DBMS may analyze results of the use scenarios to identify and correct performance issues at the DBMS.

The process of analyzing use scenario results may consume significant human resources. For example, members of the development team may analyze use scenario results in view of the DBMS, identify the underlying performance issue with the DBMS, and make corrections to the DBMS to address the performance issue.

In some examples, however, a single performance issue may manifest in the results of multiple different use cases. For example, an error leading to a DBMS performance issue in response to a first query may lead to other DBMS performance issues in response to other queries. This may increase the workload of the development team. For example, members of the development team may analyze multiple different use case results all caused by the same performance issue at the DBMS. Once the performance issue is identified and corrected, however, it may not be efficient to continue to devote human resources to analyzing use case results manifesting the now-corrected performance issue.

Various examples address these and other issues by utilizing DBMS performance data to identify equivalent performance issues at the DBMS. In some examples, a testing system may access first performance data describing a plurality of operations executed by the DBMS to implement a first query, for example, during a use scenario. The testing system may generate a key operations graph describing a flow of the operations at the DBMS. The key operations graph may express the operations performed by the DBMS to implement the first query and the relationships between the operations. The testing system may execute a graph neural network using the key operations graph as input. The testing system may also generate first query execution signature data based on an output of the graph neural network. The first query execution signature data may be compared to other query execution signature data. If the first query execution signature data is equivalent to a query execution signature data for another query, for example, from another use case, then the testing system may store an indication that the two queries are equivalent. In this way, the development team members may not need to separately analyze both of the queries/use scenarios but may, instead, consider both queries to correct a common underlying performance issue at the DBMS.

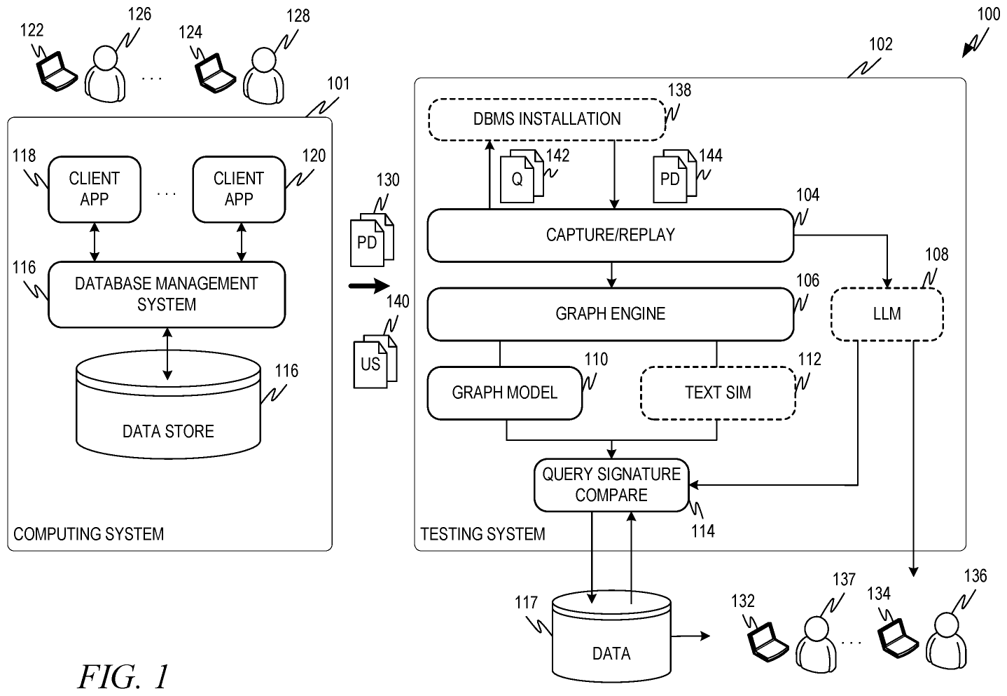

FIG. 1 is a diagram showing one example of an environment 100 comprising a computing system 101 and a testing system 102. The analytics computing system 101 may execute a DBMS 116 and/or one or more client applications 118, 120. The testing system 102 may be configured to identify equivalent performance issues at the DBMS 116.

In some examples, the client applications 118, 120 may be enterprise resource planning system (ERP) applications that are used in conjunction with the DBMS 116 to manage various different aspects of business operations for one or more customer enterprises. An example ERP software application is the S/4 HANA product available from SAP SE of Waldorf, Germany. The client applications 118, 120 may generate and utilize the data stored at the DBMS 116 to perform different enterprise operations. For example, a client application 118, 120 supporting a human resources operation may store employee records at the DBMS. A client application 118, 120 supporting accounting may use records managed by the DBMS 116 to perform various accounting-related tasks such as generating and recording invoices, purchase orders, and the like. A client application 118, 120 supporting human resources management may perform various tasks related to, for example, using data managed by the DBMS to generate and manage payroll, benefits, and the like. Other ERP applications may perform other business tasks. In some examples, the DBMS 116 may be utilized with client applications 118, 120 that are directed to non-ERP applications as well.

The computing system 101 implementing the DBMS 116 and client applications 118, 120 may be implemented in an on-premise environment and/or in a cloud environment. In an on-premise environment, an enterprise utilizing the DBMS 116 and client applications 118, 120 may maintain the computing system 101 as an on-premise computing system. The DBMS 116 and client applications 118, 120 may be executed at the on-premise computing system.

In a cloud environment, the computing system 101 is implemented by one or more servers and/or other computing devices maintained by a cloud provider and accessible remotely. In a private cloud environment, the enterprise using the DBMS 116 and client applications 118, 120 may provide applications, implement storage, and/or the like to implement the DBMS 116 and client applications 118, 120. In a public cloud environment, a cloud provider may maintain the DBMS 116 and client applications 118, 120 and provide a number of tenancies. The cloud provider may provide and maintain executables to implement the DBMS 116 and client applications 118, 120. An enterprise may purchase a tenancy to permit users associated with that enterprise to access the DBMS 116 and client applications 118, 120 to use the DBMS 116 and client applications 118, 120.

Users 126, 128 may access the computing system 101 via user computing devices 122, 124. User computing devices 122, 124 may be and/or include various different types of computing devices such as, for example, desktop computers, laptop computers, tablet computers, mobile computing devices, and/or the like. It will be appreciated, that in some on-premise applications, a user may access the computing system 101 directly via input/output components of the computing system 101 such as, for example, a keyboard and/or a monitor.

The DBMS 116 and/or client applications 118, 120 may generate performance data 130. Performance data 130 may describe the operations of the DBMS 116 during the execution of one or more queries to the DBMS 116. For example, the performance data 130 for a query may describe the operations executed by one or more engines of the DBMS 116 to execute the query, information about the operations, outputs of the operations, and relationships between operations. For example, the performance data 130 may indicate, for each operation, an execution time, an operation output, one or more inputs received from one or more precedent operations, one or more outputs provided to one or more subsequent operations, and/or the like. The performance data 130 provided by the DBMS 116 to the testing system 102 may describe queries that resulted in performance issues at the DBMS 116. The testing system 102, in some examples, receives such performance data 130 from the computing system 101 and/or from other enterprise computing systems associated with other customer enterprises utilizing versions of the DBMS 116.

In some examples, in addition to or instead of providing performance data 130, the DBMS 116 and or client applications 118, 120 provide use scenario data 140. The use scenario data 140 describes use scenarios at the DBMS 116. For example, use scenario data 140 may describe queries that are commonly executed at the DBMS 116, for example, in response to requests from one or more of the users 126, 128 and/or one or more of the client applications 118, 120. Also, it will be appreciated that, although one computing system 101 is shown in FIG. 1, multiple enterprise computing systems associated with multiple different customer enterprises may provide use scenario data 140 to the testing system 102.

The testing system 102 may be configured to utilize the performance data 130 and/or the use scenario data 140 to identify duplicate performance issues at the DBMS 116. The testing system 102 may comprise a capture/replay engine 104, a graph engine 106, a graph model engine 110, and a query signature comparison engine 114. In some examples, the testing system 102 may also comprise a large language model (LLM) engine 108, a text similarity engine 112 and/or a DBMS installation 138. The various engines 104, 106, 108, 110, 112, 114 and DBMS installations 138 may be or comprise a software components executing at the testing system 102.

The capture/replay engine 104 may receive performance data 130 and/or use scenario data 140. In some examples, the capture/replay engine 104 may utilize use scenario data 140 to provide one or more queries 142 to the DBMS installation 138. The DBMS installation 138 may be an installation of a DBMS, for example, of the same version and/or type as the DBMS 116. Accordingly, for example, the DBMS installation 138 may exhibit performance issues similar to that of the DBMS 116. The DBMS installation 138 may execute the one or more queries 142 provided by the capture/replay engine 104 according to the use scenario data 140. Performance data 144 describing the performance of the DBMS installation 138 in response to the queries 142 may be provided. The performance data 144 may be similar to the performance data 130.

The graph engine 106 may be configured to receive performance data 130, 144 and generate a key operations graph. For example, the graph engine 106 may operate on performance data 130, 144 describing the performance of the DBMS 116 or the DBMS installation 138 in response to a query. The graph engine 106 may generate a query execution graph. The query execution graph may indicate query operations for a query. The query operations may be operations executed by the DBMS 116 or DBMS installation 138 to implement the query. Each query operation may be represented in the query execution graph as a graph element, such as, for example, a node. Other graph elements connecting operations graph elements (e.g., edges) may indicate relationships between the different query operations.

The graph engine 106 may identify key operations. Key operations may be operations selected from the query operations that are associated with a negative performance issue at the DBMS. In some examples, the graph engine 106 selects a number (N) of query operations that had the highest execution time. For example, the graph engine 106 may generate a ranking of the query operations by execution time. The N operations with the highest execution time may be key operations. The graph engine 106 may generate the key operations graph, for example, by removing elements from the operations graph. The removed elements may correspond to operations that are neither key operations nor downstream from key operations. In some examples, the graph engine 106 may convert the key operations graph to a vector format. Any suitable operation or tool may be used for the conversion. An example of such a tool is the node2vec algorithm.

The graph model engine 110 may be configured to receive an indication of the key operations graph and generate query signature data describing the query. In some examples, the graph model engine 110 executes a trained computerized model, such as a neural network model. In some examples, the neural network model is a graph neural network model. In some examples, the neural network model is a Siamese neural network model comprising a graph attention convolutional branch and a graph convolutional branch. Also, in some examples, the graph model engine 110 implements multiple neural network models. For example, the key operations graph (or a representation thereof) may be provided as input to a graph neural network model. The output of the graph neural network model may be provided as input to a fully connected neural network model. The query execution signature data may be generated based on an output of the fully connected neural network.

Optionally, the testing system 102 may comprise the LLM engine 108. The LLM engine 108 may execute a trained computerized model that is or includes an LLM. The LLM may receive all or part of the performance data 130, 144 corresponding to the execution of a query. The output of the LLM may include a characterization of the query. For example, performance training data may be generated by extracting and summarizing the performance data 130. The performance training data may be used with any suitable LLM to fine-tune the LLM, thereby improving its accuracy for predictions involving the underlying DBMS.

Optionally, the testing system 102 may also implement a text similarity engine 112. The text similarity engine 112 engine may operate on key graph data for two queries to generate a text similarity score for the two queries. The text similarity score may be based on a number of common edges or other graph elements between key graph data for the first query execution and key graph data for the second query execution. An example model that may be applied by the text similarity engine 112 is given by Equation [1] below:

$$Similiarity = \frac{{\sum }_{edge ∈ SE} sim\_attribute}{max ( number of edges of two graphs )} \qquad [ 1 ]$$

In Equation [1], the numerator indicates a sum of common edges, or other common graph elements, between the key graph data for the first query execution and the key graph data for the second query execution. The denominator indicates the maximum number of edges or other graph elements between the two key graphs.

The query signature compare engine 114 may determine whether two query executions are equivalent. For example, two query executions may be equivalent if the executions manifest the same DBMS performance issue. The query signature compare engine 114 may compare the execution of at least two queries. For example, the query signature compare engine 114 may compare the execution of a first query and a second query. The query signature compare engine 114 may receive, from the graph model engine 110, query execution signature data for the first query and the second query. In some examples, the query signature compare engine 114 determines whether the two query executions are equivalent by comparing the first query execution signature data and the second query execution signature data. Any suitable comparison may be used including, for example, a cosine similarity. In some examples, the query signature compare engine 114 also considers a text similarity for the first and second query executions generated by the text similarity engine 112 and an output of the LLM engine 108.

If two query executions are determined to be equivalent, the query signature compare engine 114 may store data indicating the equivalence, for example, to a data store 117. Developer users 137, 136 may access the data store 117, for example, via user computing devices 132, 134. The developer users 137, 136 may utilize the data indicating equivalence to reduce the workload associated with debugging or otherwise correcting performance issues at the DBMS 116. For example, the developer users 137, 136 may not need to analyze every query execution. Once the developer users 137 have analyzed and corrected a first query execution, the developers may not need to spend extensive time analyzing query executions that are equivalent to the first query execution. In some examples, the developer users 137, 136 may have access to the LLM implemented by the LLM engine 108. For example, the developer users 137, 136 may receive correction suggestions describing the suggested changes to the DBMS 116 based on the identified performance issues. In some examples, the developer users 137, 136 may query the LLM to receive correction suggestions.

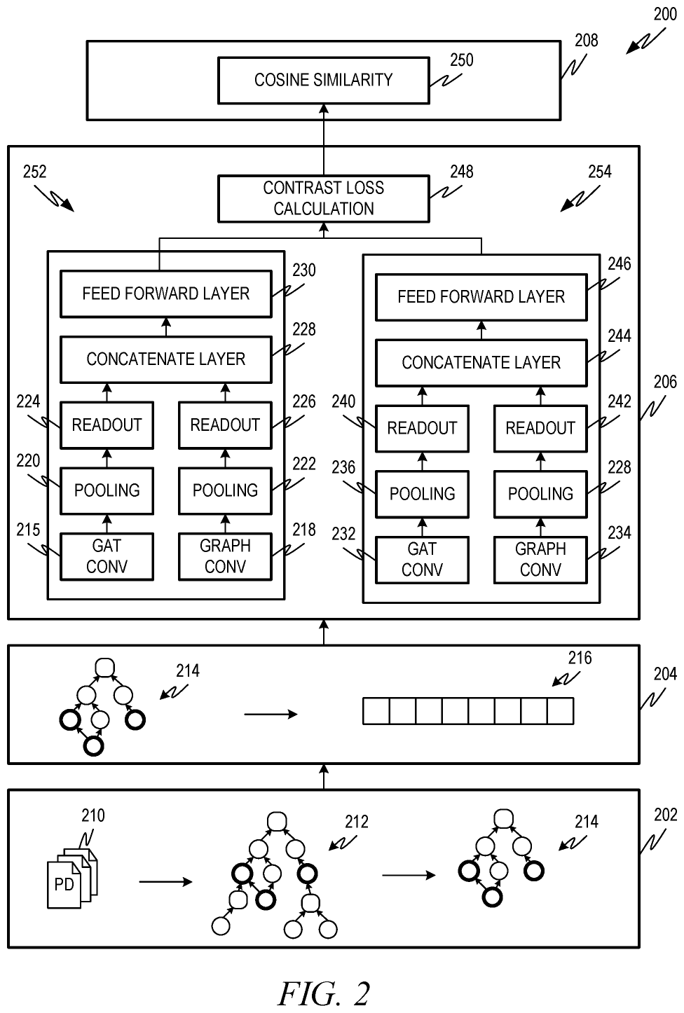

FIG. 2 is a workflow diagram showing one example of a workflow 200 that may be executed in the environment 100 to determine whether to query executions are equivalent. At operation 202, the graph engine 106 may receive performance data 210. The performance data 210 describes the execution of a first query at, for example, the DBMS 116 or the DBMS installation 138.

In this example, the graph engine 106 generates a query execution graph 212 from the performance data 210. The query execution graph 212 comprises graph elements including nodes and edges. In some examples, each node of the query execution graph 212 corresponds to an operation executed by the DBMS 116 and/or the DBMS installation 138 while executing the first query. Edges between the nodes represent relationships between the operations. For example, an edge between two nodes may indicate that the output of the operation corresponding to the first node was provided as input to the operation corresponding to the second node. Edges between nodes may include additional information such as, for example, a description of the data passed between operations including, for example, an identity of the data, a size of the data, a number of rows at one or more tables included in the data, and/or the like.

The graph engine 106 may generate a key operations graph 214, for example, from the query execution graph 212. To generate the key operations graph 214, the graph engine 106 may identify key operations. In some examples, key operations are the N operations having the highest execution time. For example, operations having higher execution times may be positively correlated to performance issues at the DBMS 116 or DBMS installation 138. The number N of key operations may be selected in any suitable manner. For example, the number of key operations may be selected based on the total number of operations. In some examples, the number N of key operations may be selected based on execution time. For example, the graph engine 106 may apply an execution time threshold to the operations. All operations having an execution time greater than the threshold may be key operations.

The graph engine 106 may remove from the query execution graph 212 nodes and edges that are upstream of the identified key operations. For example, the graph engine 106 may remove from the query execution graph 212 nodes and edges corresponding to operations that were executed prior to key operations. In some examples, operations downstream from key operations may remain. The result may be the key operations graph 214.

At operation 204, the graph engine 106 may convert the key operations graph 214 to a vector format 216. The vector format 216 may be a vector representation of the graph elements of the key operations graph 214. In some examples, the vector format 216 may be suitable to provide as input to a computerized model, such as, for example, a graphical neural network. In some examples, the graph engine may utilize a suitable graph to vector algorithm such as, for example, node2vec, to convert the key operations graph 214 to the vector format 216.

At operation 206, the graph model engine 110 may apply example graph neural network models 252 and 254. The graph neural network model 252 may be executed with input that is or is based on the key operations graph 214 and/or the vector format 216. The graph neural network model 254 may be executed with input that is based on a second key operations graph (not shown) and/or a second vector format of the second key operations graph (also not shown). The second key operations graph and/or second vector format may describe a second query execution at the DBMS 116 and/or DBMS installation 138. The second key operations graph and/or second vector format may be generated from performance data describing the second query execution, for example, as described herein including with respect to the operation 204. In this example, the second query execution is compared to the first query execution to evaluate whether the first and second query operations are equivalent and/or exhibit equivalent database performance issues.

In the example of FIG. 2, the graph neural network models 252, 254 are Siamese graph neural networks. For example, the graph neural network model 252 comprises a graph attention convolutional branch comprising graph attention convolutional nodes 215, pooling nodes 220, and readout nodes 224. The graph neural network model 252 also comprises a graph convolutional branch comprising graph convolutional nodes 218, pooling nodes 222, and readout nodes 226. The graph neural network model 254 also includes a graph attention convolutional branch, comprising graph attention convolutional nodes 232, pooling nodes 236, and readout nodes 240. Additionally, the graph neural network model 252 includes a graph convolutional branch comprising graph convolutional nodes 234, pooling nodes 220, and readout nodes 242.

The respective graph attention convolutional branches may be arranged to implement attention properties. For example, respective graph attention convolutional nodes 215, 232 may be arranged to consider input graph elements as well as contextual graph elements around the various graph elements. The respective graph convolutional branches may be arranged without explicitly considering attention properties. Outputs of the respective branches may be provided to respective concatenate layers 228, 244 and respective feedforward layers 230, 246. For example, outputs of the readout nodes 224, 226 may be provided to the concatenate layer 228. An output of the concatenate layer 228 may be provided to the feedforward layer 230. Similarly, outputs of the readout nodes 240, 242 may be provided to the concatenate layer 244. An output of the concatenate layer 244 may be provided to the feedforward layer 246.

The outputs of the respective graph neural network models 252, 254 may indicate query execution signature data for the first query execution (graph neural network model 252) and for the second query execution (graph neural network model 254). The respective outputs may be provided to a contrast loss calculation module 248, which may determine a loss or difference between the two outputs. At operation 208, the query signature compare engine 114 may apply a cosine similarity model 250 to the output of the contrast loss calculation module 248 to determine whether the first query execution and the second query execution are equivalent. For example, the first query execution and the second query execution may be equivalent if an output of the cosine similarity meets a threshold condition, such as for example, being greater than a threshold value.

It will be appreciated that the graph neural network models 252, 254 may be trained in any suitable manner. In some examples, training data may be obtained. Training data may include performance data 130, 144 describing query executions at the DBMS 116 and/or the DBMS installation 138. The training data may be labeled with an indication of desired query execution signature data associated with respective instances of performance data 130, 144. In another example, the graph neural network models 252, 254 may be trained together. For example, instances of training data may include performance data 130, 144 for a first query execution and for a second query execution. The training data may be labeled with an indication of whether the first query execution and the second query execution are reflective of equivalent database performance issues. The training data may be applied as input to the model or models 252, 254, and the model or models 252, 254 may be refined over a number of training epochs, for example, according to gradient descent or another suitable method.

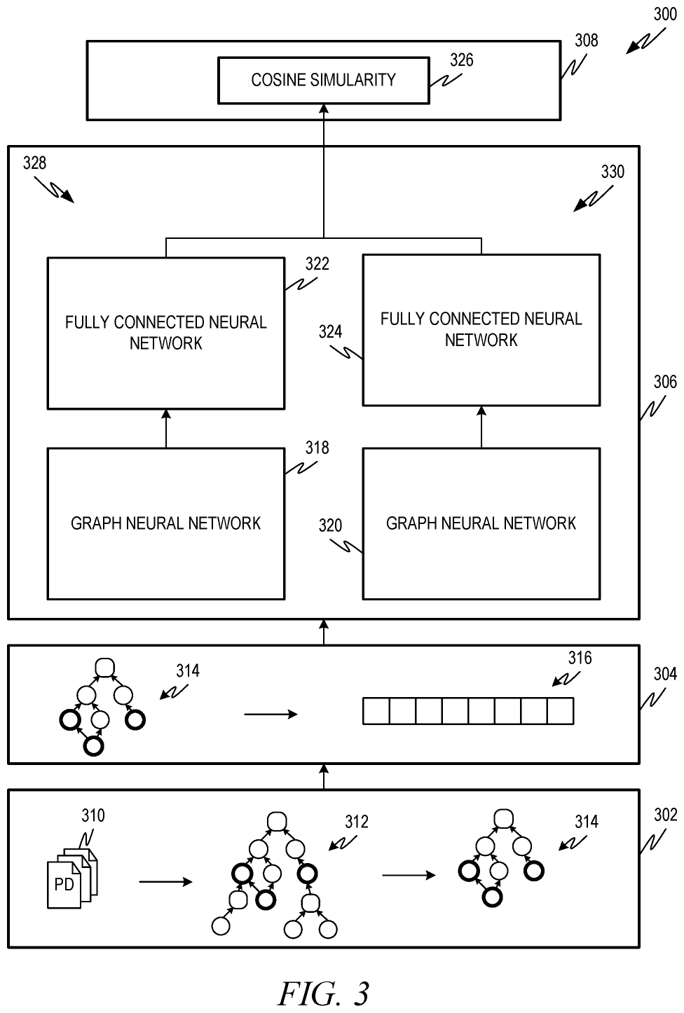

FIG. 3 is a workflow diagram showing one example of a workflow 300 that may be executed in the environment 100 to determine whether to query executions are equivalent. At operation 302, the graph engine 106 may receive performance data 310. The performance data 310 describes the execution of a first query at, for example, the DBMS 116 or the DBMS installation 138.

In this example, the graph engine 106 generates a query execution graph 312 from the performance data 310. The query execution graph 312 comprises graph elements including nodes and edges. In some examples, each node of the query execution graph 312 corresponds to an operation executed by the DBMS 116 and/or the DBMS installation 138 while executing the first query. Edges between the nodes represent relationships between the operations. For example, an edge between two nodes may indicate that the output of the operation corresponding to the first node was provided as input to the operation corresponding to the second node. Edges between nodes may include additional information such as, for example, a description of the data passed between operations including, for example, an identity of the data, a size of the data, a number of rows at one or more tables included in the data, and/or the like.

The graph engine 106 may generate a key operations graph 314, for example, from the query execution graph 312. To generate the key operations graph 314, the graph engine 106 may identify key operations. In some examples, key operations are the N operations having the highest execution time. For example, operations having a high execution time may be positively correlated to performance issues at the DBMS 116 or DBMS installation 138. The number N of key operations may be selected in any suitable manner. For example, the number and of key operations may be selected based on the total number of operations. In some examples, the number N of key operations may be selected based on execution time. For example, the graph engine 106 may apply an execution time threshold to the operations. All operations having an execution time greater than the threshold may be key operations.

The graph engine 106 may remove from the query execution graph 312 nodes and edges that are upstream of the identified key operations. For example, the graph engine 106 may remove from the query execution graph 312 nodes and edges corresponding to operations that were executed prior to key operations. In some examples, operations downstream from key operations may remain. The result may be the key operations graph 314.

At operation 304, the graph engine 106 may convert the key operations graph 314 to a vector representation 316. The vector representation 316 may be a vector representation of the graph elements of the key operations graph 314. In some examples, the vector representation 316 may be suitable to provide as input to a computerized model, such as, for example, a graphical neural network. In some examples, the graph engine may utilize a suitable graph to vector algorithm such as, for example, node2vec, to convert the key operations graph 314 to the vector representation 316.

At operation 306, the graph model engine 110 may apply one or more neural network models 318, 322, 320, 324. For example, a model branch 328 may be executed with input that is or is based on the key operations graph 314 and/or the vector representation 316. A model branch 330 may be executed with input that is based on a second key operations graph (not shown) and/or a second vector format of the second key operations graph (also not shown). The second key operations graph and/or second vector format may describe a second query execution at the DBMS 116 and/or DBMS installation 138. The second key operations graph and/or second vector format may be generated from performance data describing the second query execution, for example, as described herein including with respect to the operation 204. In this example, the second query execution is compared to the first query execution to evaluate whether the first and second query operations are equivalent and/or exhibit equivalent database performance issues.

Referring first to the branch 328, the key operations graph 314 and/or vector representation 316 may be initially supplied as input to a graph neural network model 318. An output of the graph neural network model 318 may be provided as input to a fully connected neural network model 322. Similarly, referring to the branch 330, the graph neural network model 320 may be executed within input that is or is based on a key operations graph and/or vector representation describing the second query execution. An output of the graph neural network model 320 may be provided as input to the fully connected neural network model 324. The output of the respective branches 328, 330 may be and/or form a basis of query execution signature data for the first query execution and the second query execution, respectively.

At operation 308, the outputs of the respective branches 328, 330 may be used to determine whether the first query execution and the second query execution are equivalent (e.g. whether the first query execution and the second query execution exhibit equivalent database performance issues). For example, the query signature compare engine 114 may apply a cosigned similarity model 326 to the respective outputs.

It will be appreciated that the graph neural network models 318, 320 and fully connected neural network models 322, 324 may be trained in any suitable manner. In some examples, training data may be obtained. Training data may include performance data 130, 144 describing query executions at the DBMS 116 and/or the DBMS installation 138. The training data may be labeled with an indication of desired query execution signature data associated with respective instances of performance data 130, 144. In another example, branches 328, 330 may be trained together. For example, instances of training data may include performance data 130, 144 for a first query execution and for a second query execution. The training data may be labeled with an indication of whether the first query execution and the second query execution are reflective of equivalent database performance issues. The training data may be applied as input to the model or models 252, 254 and the model or models 252, 254 may be refined over a number of training epochs, for example, according to gradient descent or another suitable method.

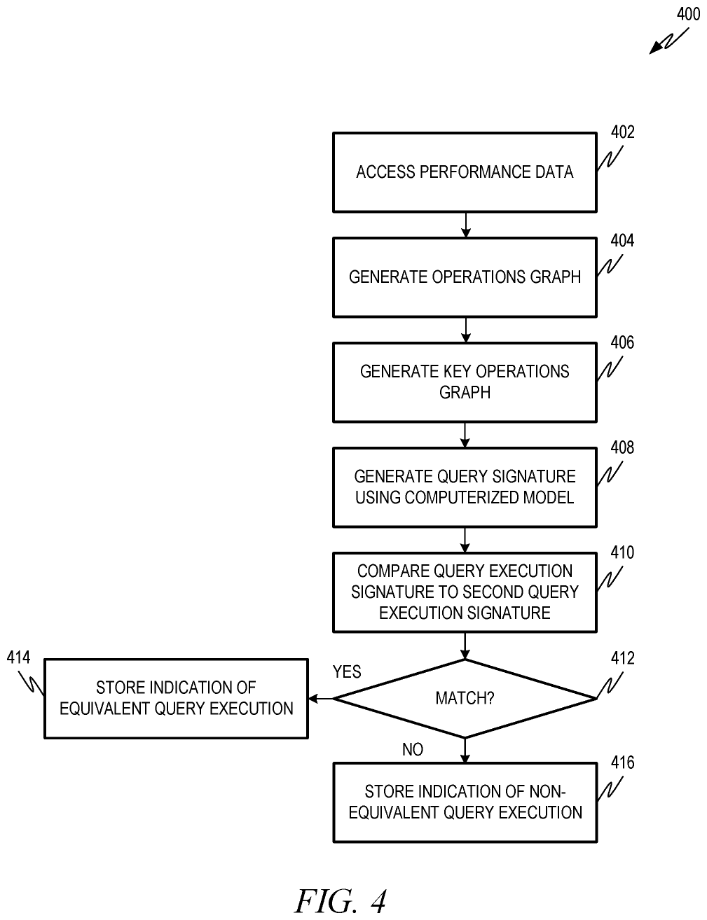

FIG. 4 is a flowchart showing one example of a process flow 400 that may be executed in the environment 100 of FIG. 1 to determine whether two query executions are equivalent. At operation 402, the testing system 102 (e.g., the capture/replay engine 104 thereof) may access performance data. The performance data may describe a first query execution at the DBMS 116 and/or the DBMS installation 138. At operation 404, the testing system 102 (the graph engine 106 thereof) may generate a first query execution graph describing the first query execution. At operation 406, the testing system 102 may generate a key operations graph from the query execution graph. For example, the testing system 102 may identify N key operations from the query execution graph and modify the query execution graph, as described herein. In some examples, the key operations graph may be converted to a vector form, as described herein.

At operation 408, the testing system 102 (e.g., the graph model engine 110 thereof) may generate a query execution signature for the first query execution using at least one computerized model and the key operations graph. For example, the testing system 102 may execute a graph neural network model using the key operations graph and/or a representation thereof as input, as described herein. At operation 410, the testing system 102 (the query signature compare engine 114) may compare the query execution signature for the first query execution to a second query execution signature for a second query execution. The second query execution signature may have been generated in a manner similar to that of the first query execution signature.

At operation 412, the testing system 102 may determine if the first query execution signature matches the second query execution signature. This may be performed in any suitable manner, for example, as described herein. If the first query execution signature matches the second query execution signature, then the testing system 102 may, at operation 414, store an indication that the first query execution and the second query execution are equivalent. Developer users 137, 136 may access the stored indication and, in response, consider the first query execution and the second query execution together when correcting a performance issue at the DBMS 116. If the first query execution and the second query execution are not equivalent, then the testing system 102 may, at operation 416, store an indication that the first query execution and the second query execution are distinct or not equivalent. Developer users 137, 136 may access the stored indication and, in response, consider the first query execution and the second query execution separately when correcting respective DBMS performance issues associated with the first and second query executions.

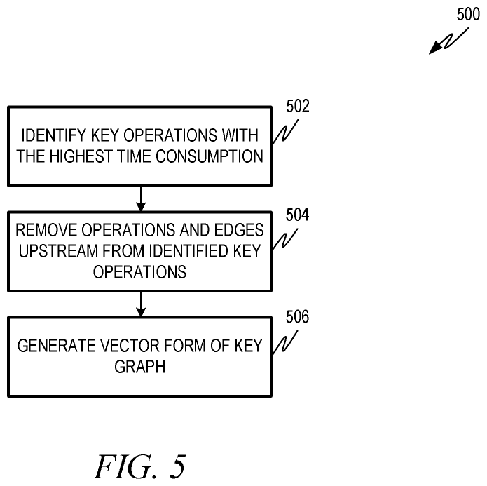

FIG. 5 is a flowchart showing one example of a process flow 500 that may be executed by the graph engine 106 to generate a key operations graph. The process flow 500 may begin with a query execution graph and/or performance data 130, 144 describing the execution of a query. At operation 502, the graph engine 106 may identify key operations for the query execution having the highest time consumption. This may include, for example, ranking the operations for the query execution by time consumption and selecting the N highest ranked operations, where N is a predetermined number. In another example, it may include selecting all query operations having time consumption above a threshold time.

At operation 504, the graph engine 106 may remove from the query execution graph operations and edges that are upstream from the identified key operations. At operation 506, the graph engine 106 may convert the resulting key operations graph to a vector format, for example, as described herein.

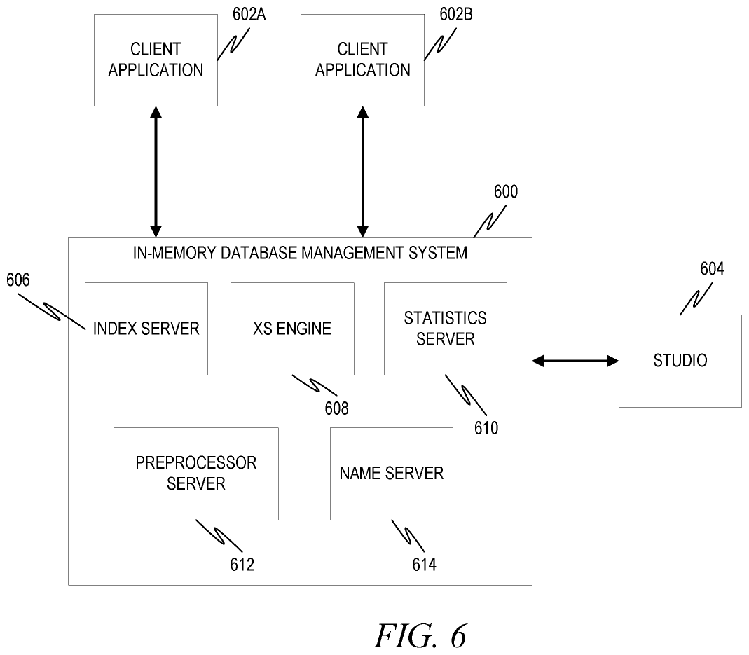

FIG. 6 is a diagram illustrating an example of an in-memory database management system 600. An in-memory database stores data primarily at main memory, such as a random access memory. This is different than databases that primarily employ a disk storage mechanism. In some examples, the database management system 600 may be or include an example of the HANA system from SAP SE of Walldorf, Germany. Although various features of environmental metric integration are described herein in the context of an in-memory database, carbon footprint optimization may be generally performed at any suitable database management system. The in-memory database management system 600 shows one example way that the DBMS 116 and/or the DBMS installation 138 may be implemented. It will be appreciated, however, that the DBMS 116 and/or DBMS installation 138 may also be implemented for database management systems that are not in-memory database management systems.

The in-memory database management system 600 may be coupled to one or more client applications 602A, 602B. Client applications 602A, 602B may be ERP applications, for example, as described herein. The client applications 602A, 602B may communicate with the in-memory database management system 600 through a number of different protocols, including Structured Query Language (SQL), Multidimensional Expressions (MDX), Hypertext Transfer Protocol (HTTP), Representational State Transfer (REST), Hypertext Markup Language (HTML).

FIG. 6 also shows a studio 604 that may be used to perform modeling by accessing the in-memory database management system 600. In some examples, the studio 604 may allow complex analysis to be performed on data drawn not only from real time event data and windows, but also from stored database information.

The in-memory database management system 600 may comprise a number of different components, including an index server 606, an XS engine 608, a statistics server 610, a preprocessor server 612, and a name server 614. These components may operate on a single computing device or may be spread among multiple computing devices (e.g., separate servers). The index server 606 contains the actual data and the engines for processing the data. It may also coordinate and uses the other servers.

The XS engine 608 allows clients to connect to the in-memory database management system 600 using web protocols, such as HTTP. Although the XS engine 608 is illustrated as a component of the in-memory database management system 600, in some examples, the XS engine may be implemented as one or more Application Program Interfaces (APIs) and/or services positioned between the client applications 602A, 602B and the in-memory database management system 600. In some examples, the XS engine 608 may handle client requests received in languages other than SQL such as, for example, MDX, HTTP, REST, HTML, etc.

The statistics server 610 collects information about status, performance, and resource consumption from all the other server components. The statistics server 610 can be accessed from the studio 604 to obtain the status of various alert monitors. In some examples, the statistics server 610 may generate use scenario data 140 and or performance data 130, 144.

The preprocessor server 612 is used for analyzing text data and extracting the information on which the text search capabilities are based.

The name server 614 holds information about the database topology. This is used in a distributed system with instances of the database on different hosts. The name server 614 knows where the components are running and which data is located on which server. In an example embodiment, a separate enqueue server may operate in the manner described above with respect to enqueue servers, specifically with regard to creating and managing light-weight enqueue sessions.

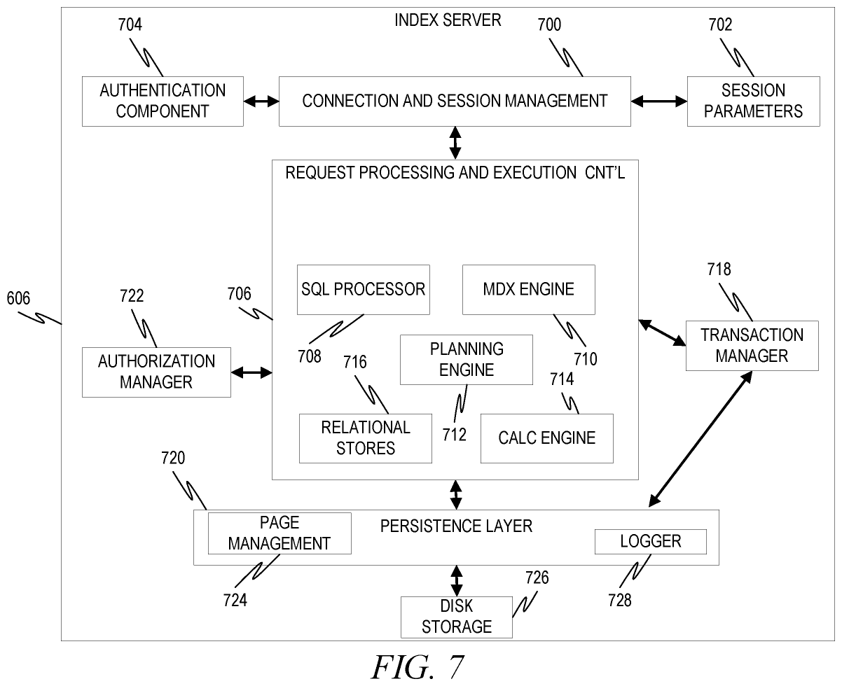

FIG. 7 is a diagram illustrating an example of the index server 606. Specifically, the index server 606 of FIG. 6 is depicted in more detail. The index server 606 includes a connection and session management component 700, which is responsible for creating and managing sessions and connections for the database clients (e.g. client applications 602A, 602B). Once a session is established, clients can communicate with the database system using SQL statements. For each session, a set of session parameters 702 may be maintained, such as auto-commit, current transaction isolation level, etc. Users (e.g., system administrators, developers) may be authenticated by the database system itself (e.g., by logging in with log-in information such as a user name and password, using an authentication component 704) or authentication can be delegated to an external authentication provider such as a Lightweight Directory Access Protocol (LDAP) directory.

Client requests can be analyzed and executed by a set of components summarized as request processing and execution control 706. An SQL processor 708 checks the syntax and semantics of the client SQL statements and generates a logical execution plan. MDX is a language for querying and manipulating multidimensional data stored in Online Analytical Processing (OLAP) cubes. As such, an MDX engine 710 may be provided to allow for the parsing and executing of MDX commands. A planning engine 712 allows applications to execute basic planning operations in the database layer. One such operation is to create a new version of a dataset as a copy of an existing dataset, while applying filters and transformations.

A calculation engine 714 implements the various SQL script and planning operations. The calculation engine 714 creates a logical execution plan for calculation models derived from SQL script, MDX, planning, and domain-specific models. This logical execution plan may include, for example, breaking up a model into operations that can be processed in parallel. The data is stored in relational stores 716, which implement a relational database in main memory.

Each SQL statement may be processed in the context of a transaction. New sessions are implicitly assigned to a new transaction. A transaction manager 718 coordinates database transactions, controls transactional isolation, and keeps track of running and closed transactions. When a transaction is committed or rolled back, the transaction manager 718 informs the involved engines about this event so they can execute needed actions. The transaction manager 718 also cooperates with a persistence layer 720 to achieve atomic and durable transactions.

An authorization manager 722 is invoked by other database system components to check whether the user has the specified privileges to execute the requested operations. The database system allows for the granting of privileges to users or roles. A privilege grants the right to perform a specified operation on a specified object.

The persistence layer 720 ensures that the database is restored to the most recent committed state after a restart and that transactions are either completely executed or completely undone. To achieve this goal in an efficient way, the persistence layer 720 uses a combination of write-ahead logs, shadow paging, and save points. The persistence layer 720 also offers a page management interface 724 for writing and reading data to a separate disk storage 726, and also contains a logger 728 that manages the transaction log. Log entries can be written implicitly by the persistence layer 720 when data is written via the persistence interface or explicitly by using a log interface.

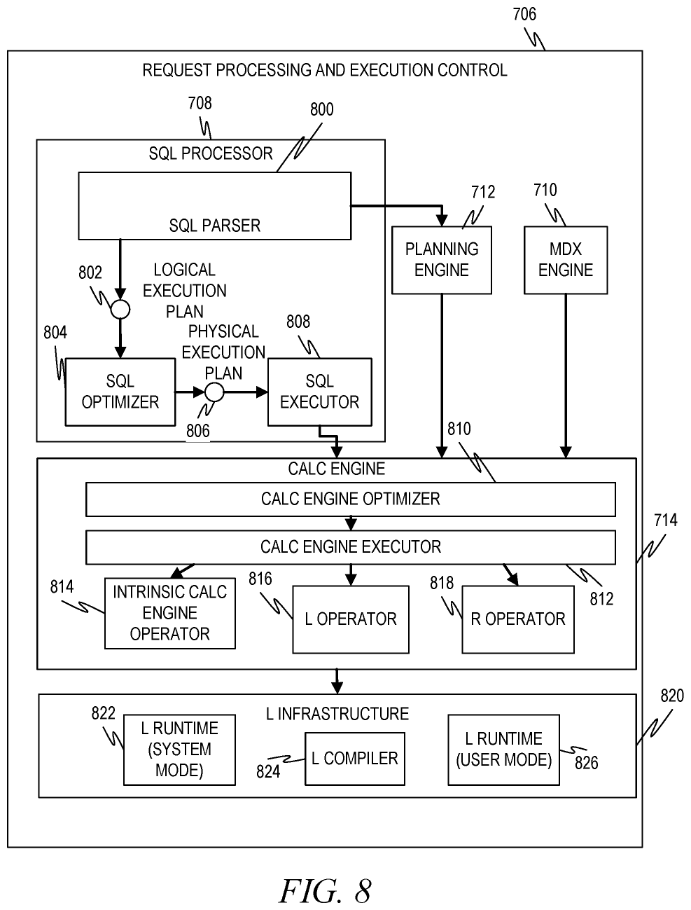

FIG. 8 is a diagram illustrating one example of the request processing and execution control 706. This diagram depicts the request processing and execution control 706 of FIG. 7 in more detail. The SQL processor 708 contains an SQL parser 800, which parses the SQL statement and generates a logical execution plan 802, which it passes to an SQL optimizer 804. The SQL optimizer 804 optimizes the logical execution plan 802 and converts it to a physical execution plan 806, which it then passes to a SQL executor 808. The calculation engine 714 implements the various SQL script and planning operations, and includes a calc engine optimizer 810, which optimizes the operations, and a calc engine executor 812, which executes the operations, as well as an intrinsic calc engine operator 814, an L operator 816, and an R operator 818.

An L infrastructure 820 includes a number of components to aid in the running of L procedures, including an L-runtime (system mode) 822, an L compiler 824, and an L-runtime (User mode) 826.

In view of the disclosure above, various examples are set forth below. It should be noted that one or more features of an example, taken in isolation or combination, should be considered within the disclosure of this application.

### EXAMPLES

Example 1 is a testing computing system for testing a database management system, comprising: at least one processor programmed to perform operations comprising: accessing first performance data describing a plurality of operations executed by the database management system to implement a first query; executing a graph neural network using the first performance data to generate a graph neural network output; generating first query execution signature data describing the execution of the first query at the database management system, the generating of the first query execution signature data being based at least in part on the graph neural network output; comparing the first query execution signature data to second query execution signature data describing execution of a second query at the database management system; and based on the comparing, storing an indication that the execution of the first query at the database management system and the execution of the second query at the database management system are equivalent.

In Example 2, the subject matter of Example 1 optionally includes the operations further comprising: selecting a first portion of the plurality of operations having higher execution times than a second portion of the plurality of operations; and generating a key operations graph, the key operations graph comprising a plurality of graph elements corresponding to the first portion of the plurality of operations the executing of the graph neural network being based at least in part on the key operations graph.

In Example 3, the subject matter of Example 2 optionally includes the operations further comprising determining a number of common graph elements between the key operations graph and a second key operations graph comprising a second plurality of graph elements corresponding to operations executed by the database management system to implement the second query, the storing of the indication that the execution of the first query at the database management system and the execution of the second query at the database management system are equivalent also being based at least in part on the number of common graph elements.

In Example 4, the subject matter of any one or more of Examples 2-3 optionally includes the selecting of the first portion of the plurality of operations comprising ranking of the plurality of operations by execution time.

In Example 5, the subject matter of any one or more of Examples 1-4 optionally includes the graph neural network being a Siamese graph neural network comprising a graph attention convolutional branch and a graph convolutional branch.

In Example 6, the subject matter of Example 5 optionally includes the graph neural network output being based at least in part on a concatenation of the graph attention convolutional branch and an output of the graph convolutional branch.

In Example 7, the subject matter of any one or more of Examples 1-6 optionally includes the operations further comprising executing a fully connected neural network using the graph neural network output, the first query execution signature data also being based at least in part on an output of the fully connected neural network.

In Example 8, the subject matter of any one or more of Examples 1-7 optionally includes the comparing comprising generating a cosine similarity between the first query execution signature data and the second query execution signature data.

In Example 9, the subject matter of any one or more of Examples 1-8 optionally includes the operations further comprising executing a large language model based at least in part on the first performance data to generate a large language model output, the storing of the indication that the execution of the first query at the database management system and the execution of the second query at the database management system are equivalent also being based at least in part on the large language model output.

Example 10 is a method for testing a database management system, comprising: accessing a first performance data describing a plurality of operations executed by the database management system to implement a first query; executing a graph neural network using the first performance data to generate a graph neural network output; generating first query execution signature data describing the execution of the first query at the database management system, the generating of the first query execution signature data being based at least in part on the graph neural network output; comparing the first query execution signature data to second query execution signature data describing execution of a second query at the database management system; and based on the comparing, storing an indication that the execution of the first query at the database management system and the execution of the second query at the database management system are equivalent.

In Example 11, the subject matter of Example 10 optionally includes selecting a first portion of the plurality of operations having higher execution times than a second portion of the plurality of operations; and generating a key operations graph, the key operations graph comprising a plurality of graph elements corresponding to the first portion of the plurality of operations the executing of the graph neural network being based at least in part on the key operations graph.

In Example 12, the subject matter of Example 11 optionally includes determining a number of common graph elements between the key operations graph and a second key operations graph comprising a second plurality of graph elements corresponding to operations executed by the database management system to implement the second query, the storing of the indication that the execution of the first query at the database management system and the execution of the second query at the database management system are equivalent also being based at least in part on the number of common graph elements.

In Example 13, the subject matter of any one or more of Examples 11-12 optionally includes the selecting of the first portion of the plurality of operations comprising ranking of the plurality of operations by execution time.

In Example 14, the subject matter of any one or more of Examples 10-13 optionally includes the graph neural network being a Siamese graph neural network comprising a graph attention convolutional branch and a graph convolutional branch.

In Example 15, the subject matter of Example 14 optionally includes the graph neural network output being based at least in part on a concatenation of the graph attention convolutional branch and an output of the graph convolutional branch.

In Example 16, the subject matter of any one or more of Examples 10-15 optionally includes executing a fully connected neural network using the graph neural network output, the first query execution signature data also being based at least in part on an output of the fully connected neural network.

In Example 17, the subject matter of any one or more of Examples 10-16 optionally includes the comparing comprising generating a cosine similarity between the first query execution signature data and the second query execution signature data.

In Example 18, the subject matter of any one or more of Examples 10-17 optionally includes executing a large language model based at least in part on the first performance data to generate a large language model output, the storing of the indication that the execution of the first query at the database management system and the execution of the second query at the database management system are equivalent also being based at least in part on the large language model output.

Example 19 is a non-transitory machine-readable medium comprising instructions thereon that, when executed by at least one processor, because the at least one processor to perform operations comprising: accessing a first performance data describing a plurality of operations executed by a database management system to implement a first query; executing a graph neural network using the first performance data to generate a graph neural network output; generating first query execution signature data describing the execution of the first query at the database management system, the generating of the first query execution signature data being based at least in part on the graph neural network output; comparing the first query execution signature data to second query execution signature data describing execution of a second query at the database management system; and based on the comparing, storing an indication that the execution of the first query at the database management system and the execution of the second query at the database management system are equivalent.

In Example 20, the subject matter of Example 19 optionally includes the operations further comprising: selecting a first portion of the plurality of operations having higher execution times than a second portion of the plurality of operations; and generating a key operations graph, the key operations graph comprising a plurality of graph elements corresponding to the first portion of the plurality of operations the executing of the graph neural network being based at least in part on the key operations graph.

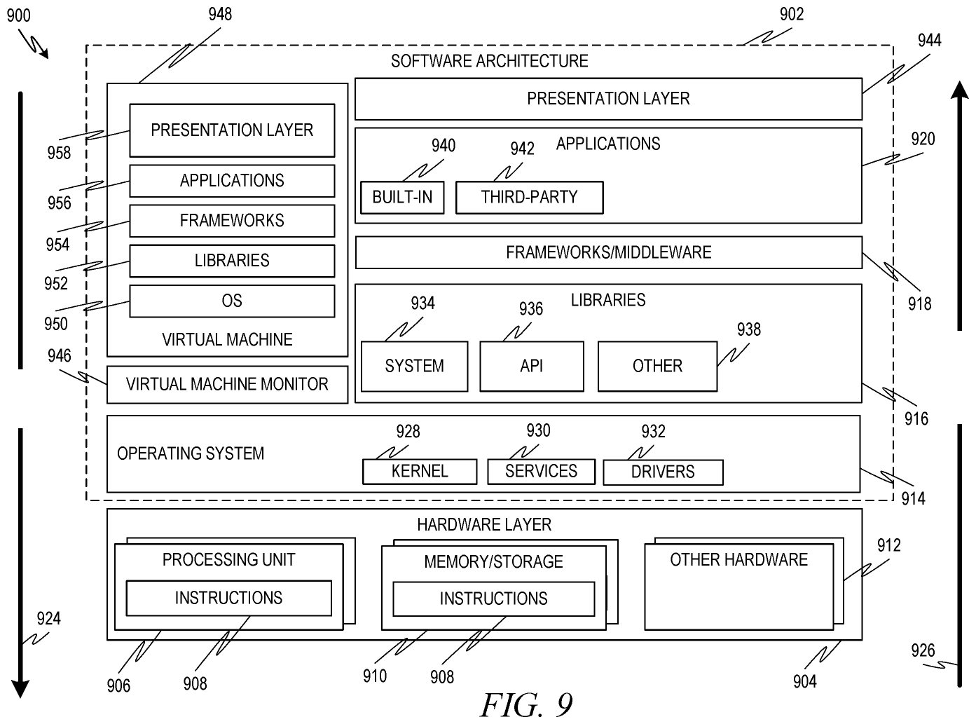

FIG. 9 is a block diagram 900 showing one example of a software architecture 902 for a computing device. The software architecture 902 may be used in conjunction with various hardware architectures, for example, as described herein. FIG. 9 is merely a non-limiting example of a software architecture and many other architectures may be implemented to facilitate the functionality described herein. The software architecture 902 and various other components described in FIG. 9 may be used to implement various other systems described herein. For example, the software architecture 902 shows one example way for implementing a testing system 102 or other computing devices described herein.

In FIG. 9, a representative hardware layer 904 is illustrated and can represent, for example, any of the above referenced computing devices. In some examples, the hardware layer 904 may be implemented according to the architecture of the computer system of FIG. 9.

The representative hardware layer 904 comprises one or more processing units 906 having associated executable instructions 908. Executable instructions 908 represent the executable instructions of the software architecture 902, including implementation of the methods, modules, systems, and components, and so forth described herein and may also include memory and/or storage modules 910, which also have executable instructions 908. Hardware layer 904 may also comprise other hardware as indicated by other hardware 912 which represents any other hardware of the hardware layer 904, such as the other hardware illustrated as part of the software architecture 902.

In the example architecture of FIG. 9, the software architecture 902 may be conceptualized as a stack of layers where each layer provides particular functionality. For example, the software architecture 902 may include layers such as an operating system 914, libraries 916, middleware layer 918 (sometimes referred to as frameworks), applications 920, and presentation layer 944. Operationally, the applications 920 and/or other components within the layers may invoke API calls 924 through the software stack and access a response, returned values, and so forth illustrated as messages 926 in response to the API calls 924. The layers illustrated are representative in nature and not all software architectures have all layers. For example, some mobile or special purpose operating systems may not provide the middleware layer 918, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. In some examples, the services 930 include an interrupt service. The interrupt service may detect the receipt of an interrupt and, in response, cause the software architecture 902 to pause its current processing and execute an interrupt service routine (ISR) when an interrupt is accessed.

The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, Near Field Communication (NFC) drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than to interface directly with the underlying operating system 914 functionality (e.g., kernel 928, services 930 and/or drivers 932). The libraries 916 may include system 934 libraries (e.g., C standard library) that may provide functions such as memory allocation functions, string manipulation functions, mathematic functions, and/or the like. In addition, the libraries 916 may include API libraries 936 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and/or the like. The libraries 916 may also include a wide variety of other libraries 938 to provide many other APIs to the applications 920 and other software components/modules.

The middleware layer 918 (also sometimes referred to as frameworks) may provide a higher-level common infrastructure that may be utilized by the applications 920 and/or other software components/modules. For example, the middleware layer 918 may provide various graphic user interface (GUI) functions, high-level resource management, high-level location services, and so forth. The middleware layer 918 may provide a broad spectrum of other APIs that may be utilized by the applications 920 and/or other software components/modules, some of which may be specific to a particular operating system or platform.

The applications 920 include built-in applications 940 and/or third-party applications 942. Examples of representative built-in applications 940 may include, but are not limited to, a contacts application, a browser application, a book reader application, a location application, a media application, a messaging application, and/or a game application. Third-party applications 942 may include any of the built-in applications 940 as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 942 may invoke the API calls 924 provided by the mobile operating system, such as operating system 914, to facilitate functionality described herein.

The applications 920 may utilize built-in operating system functions (e.g., kernel 928, services 930 and/or drivers 932), libraries (e.g., system 934, API libraries 936, and other libraries 938), and middleware layer 918 to create user interfaces to interact with users of the system. Alternatively, or additionally, in some systems interactions with a user may occur through a presentation layer, such as presentation layer 944. In these systems, the application/module “logic” can be separated from the aspects of the application/module that interact with a user.

Some software architectures utilize virtual machines. For example, the various environments described herein may implement one or more virtual machines executing to provide a software application or service. The example of FIG. 9 illustrates by virtual machine 948. A virtual machine creates a software environment where applications/modules can execute as if they were executing on a hardware computing device. A virtual machine 948 is hosted by a host operating system (operating system 914) and typically, although not always, has a virtual machine monitor 946, which manages the operation of the virtual machine 948 as well as the interface with the host operating system (i.e., operating system 914). A software architecture executes within the virtual machine 948. The software architecture may be or include, for example, an operating system 950, libraries 952, frameworks/middleware 954, applications 956 and/or presentation layer 958. These layers of software architecture executing within the virtual machine 948 can be the same as corresponding layers previously described or may be different.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

Computer software, including code for implementing software services, can be written in any form of programming language, including compiled or interpreted languages, and it can be deployed in any form, including as a standalone program or as a module, subroutine, or other unit suitable for use in a computing environment. Computer software can be deployed to be executed on one computer or on multiple computers at one site or distributed across multiple sites and interconnected by a communication network.

In example embodiments, operations may be performed by one or more programmable processors executing a computer program to perform functions by operating on input data and generating output.

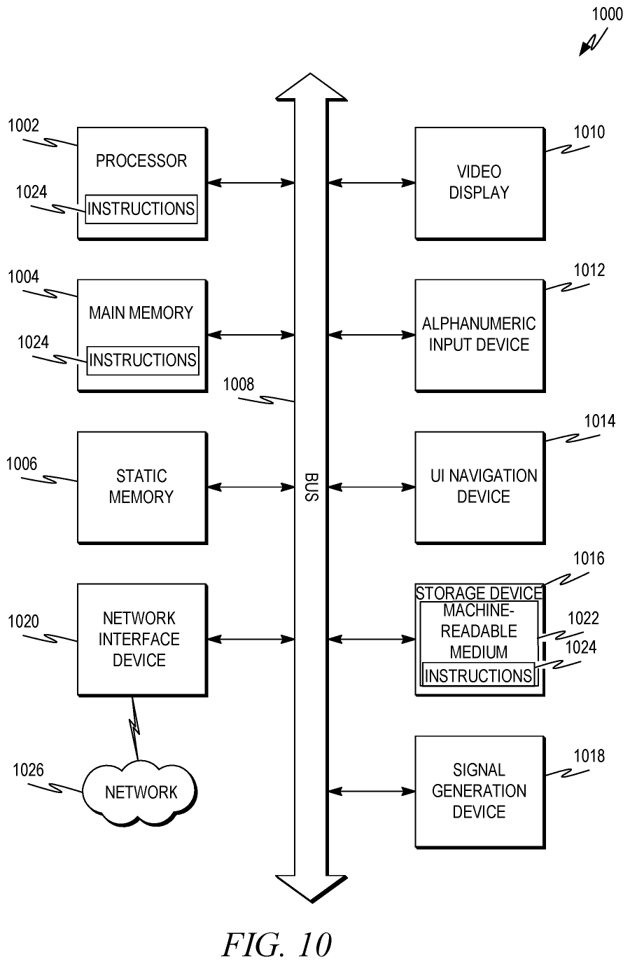

FIG. 10 is a block diagram of a machine in the example form of a computer system 1000 within which instructions 1024 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004, and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard or a touch-sensitive display screen), a user interface (UI) navigation (or cursor control) device 1014 (e.g., a mouse), a storage device 1016, such as a disk drive unit, a signal generation device 1018 (e.g., a speaker), and a network interface device 1020.

The storage device 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting machine-readable media 1022.

While the machine-readable medium 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding, or carrying instructions 1024 for execution by the machine and that cause the machine to perform any one or more of the methodologies of the present disclosure, or that is capable of storing, encoding, or carrying data structures utilized by or associated with such instructions 1024. The term “machine-readable medium” shall accordingly be taken to include, but not be limited to, solid-state memories, and optical and magnetic media. Specific examples of machine-readable media 1022 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi and WiMax networks). The term “transmission medium” shall be taken to include any intangible medium that is capable of storing, encoding, or carrying instructions 1024 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A testing computing system for testing a database management system, comprising:
at least one processor programmed to perform operations comprising:
accessing first performance data describing a plurality of operations executed by the database management system to implement a first query;
executing a graph neural network using the first performance data to generate a graph neural network output;
generating first query execution signature data describing the execution of the first query at the database management system, the generating of the first query execution signature data being based at least in part on the graph neural network output;
comparing the first query execution signature data to second query execution signature data describing execution of a second query at the database management system; and
based on the comparing, storing an indication that the execution of the first query at the database management system and the execution of the second query at the database management system are equivalent.

2. The testing computing system of claim 1, the operations further comprising:
selecting a first portion of the plurality of operations having higher execution times than a second portion of the plurality of operations; and
generating a key operations graph, the key operations graph comprising a plurality of graph elements corresponding to the first portion of the plurality of operations the executing of the graph neural network being based at least in part on the key operations graph.

3. The testing computing system of claim 2, the operations further comprising determining a number of common graph elements between the key operations graph and a second key operations graph comprising a second plurality of graph elements corresponding to operations executed by the database management system to implement the second query, the storing of the indication that the execution of the first query at the database management system and the execution of the second query at the database management system are equivalent also being based at least in part on the number of common graph elements.

4. The testing computing system of claim 2, the selecting of the first portion of the plurality of operations comprising ranking of the plurality of operations by execution time.

5. The testing computing system of claim 1, the graph neural network being a Siamese graph neural network comprising a graph attention convolutional branch and a graph convolutional branch.

6. The testing computing system of claim 5, the graph neural network output being based at least in part on a concatenation of the graph attention convolutional branch and an output of the graph convolutional branch.

7. The testing computing system of claim 1, the operations further comprising executing a fully connected neural network using the graph neural network output, the first query execution signature data also being based at least in part on an output of the fully connected neural network.

8. The testing computing system of claim 1, the comparing comprising generating a cosine similarity between the first query execution signature data and the second query execution signature data.

9. The testing computing system of claim 1, the operations further comprising executing a large language model based at least in part on the first performance data to generate a large language model output, the storing of the indication that the execution of the first query at the database management system and the execution of the second query at the database management system are equivalent also being based at least in part on the large language model output.

10. A method for testing a database management system, comprising:
accessing a first performance data describing a plurality of operations executed by the database management system to implement a first query;
executing a graph neural network using the first performance data to generate a graph neural network output;
generating first query execution signature data describing the execution of the first query at the database management system, the generating of the first query execution signature data being based at least in part on the graph neural network output;
comparing the first query execution signature data to second query execution signature data describing execution of a second query at the database management system; and
based on the comparing, storing an indication that the execution of the first query at the database management system and the execution of the second query at the database management system are equivalent.

11. The method of claim 10, further comprising:
selecting a first portion of the plurality of operations having higher execution times than a second portion of the plurality of operations; and
generating a key operations graph, the key operations graph comprising a plurality of graph elements corresponding to the first portion of the plurality of operations the executing of the graph neural network being based at least in part on the key operations graph.

12. The method of claim 11, further comprising determining a number of common graph elements between the key operations graph and a second key operations graph comprising a second plurality of graph elements corresponding to operations executed by the database management system to implement the second query, the storing of the indication that the execution of the first query at the database management system and the execution of the second query at the database management system are equivalent also being based at least in part on the number of common graph elements.

13. The method of claim 11, the selecting of the first portion of the plurality of operations comprising ranking of the plurality of operations by execution time.

14. The method of claim 10, the graph neural network being a Siamese graph neural network comprising a graph attention convolutional branch and a graph convolutional branch.

15. The method of claim 14, the graph neural network output being based at least in part on a concatenation of the graph attention convolutional branch and an output of the graph convolutional branch.

16. The method of claim 10, further comprising executing a fully connected neural network using the graph neural network output, the first query execution signature data also being based at least in part on an output of the fully connected neural network.

17. The method of claim 10, the comparing comprising generating a cosine similarity between the first query execution signature data and the second query execution signature data.

18. The method of claim 10, further comprising executing a large language model based at least in part on the first performance data to generate a large language model output, the storing of the indication that the execution of the first query at the database management system and the execution of the second query at the database management system are equivalent also being based at least in part on the large language model output.

19. A non-transitory machine-readable medium comprising instructions thereon that, when executed by at least one processor, because the at least one processor to perform operations comprising:
accessing a first performance data describing a plurality of operations executed by a database management system to implement a first query;
executing a graph neural network using the first performance data to generate a graph neural network output;
generating first query execution signature data describing the execution of the first query at the database management system, the generating of the first query execution signature data being based at least in part on the graph neural network output;
comparing the first query execution signature data to second query execution signature data describing execution of a second query at the database management system; and
based on the comparing, storing an indication that the execution of the first query at the database management system and the execution of the second query at the database management system are equivalent.

20. The medium of claim 19, the operations further comprising:
selecting a first portion of the plurality of operations having higher execution times than a second portion of the plurality of operations; and
generating a key operations graph, the key operations graph comprising a plurality of graph elements corresponding to the first portion of the plurality of operations the executing of the graph neural network being based at least in part on the key operations graph.
